(19) United States
(12) Patent Application Publication
(10) Pub. No.: US 2011/0064949 A1
(43) Pub. Date: Mar. 17, 2011

(54) ELECTROSPUN NANO FABRIC FOR IMPROVING IMPACT RESISTANCE AND INTERLAMINAR STRENGTH

(76) Inventors: Ronnie L. Bolick, Trinity, NC (US); Ajit D. Kelkar, Greensboro, NC (US); Sachin Shendokar, Greensboro, NC (US)

(21) Appl. No.: 12/815,043

(22) Filed: Jun. 14, 2010

Related U.S. Application Data
(60) Provisional application No. 61/186,546, filed on Jun. 12, 2009.

(51) Int. Cl. B29C 47/00; B32B 27/02

(52) U.S. Cl. 428/394; 264/465

(57) ABSTRACT

The present invention provides a process for forming a composite material having improved interlaminar properties.

### RELATED APPLICATION DATA

This application claims the benefit of U.S. Provisional Patent Application Ser. No. 61/186,546 filed Jun. 12, 2009, the disclosure of which is incorporated by reference herein in its entirety.

### FIELD OF THE INVENTION

The present invention generally concerns methods of manufacturing composite materials using a process that imparts an improvement in interlaminar properties over conventional processes for manufacturing composite materials.

### BACKGROUND OF THE INVENTION

Delamination of the fiber layers is a common failure mechanism in woven fiber composites. Several techniques have been cited in the literature to improve the interlaminar properties of the polymer composites. Such techniques include three-dimensional stitching, z-pinning, etc. [1, 2]. While these techniques may appear to improve interlaminar properties in woven composites, they can actually lead to a reduction of the in-plane properties, for example, lowered tensile and compression strengths.

### BRIEF DESCRIPTION OF THE DRAWINGS

FIG. 1 presents a scanning electron microscope (SEM) micrograph of the electrospun fibers according to embodiments of the present invention.

FIG. 2 presents SEM factographs depicting interaction of TEOS electrospun fibers in the MSBS test.

### SUMMARY OF THE INVENTION

Embodiments of the present invention provide processes for forming a composite material having improved interlaminar properties.

In some embodiments, silica glass nanofiber layers are produced by an electrospinning process and are directly deposited onto conventional woven fiber mat layers, and the consolidated composite laminates are subsequently processed using the heated vacuum assisted resin transfer moulding (H-VARTM) process.

In some embodiments, tetra ethyl orthothosilicate (TEOS) nanofibers are manufactured using an electrospinning technique in fiberglass-epoxy resin composite laminates to provide improved interlaminar properties.

In some embodiments, the nanofibers have a diameter in a range of about 50-10 nm.

In some embodiments, electrospun coated fiber glass woven mats are impregnated with an epoxy resin using an (H-VARTM) process.

In some embodiments, processes of the present invention utilize high-voltage, lower current to electrospin nanofibers via a sol-gel solution onto a substrate. Dimensional increases such as weight and thickness may be on the order of less than one percent with as much as an 18-30 percent increase in mechanical properties.

In some embodiments, the present invention provides a process for forming a composite material including (a) subjecting a silica polymer material in a solvent to an electrospinning technique; and (b) impregnating the electrospun product of (a) with a resin material, wherein said process of impregnating the electrospun product is carried out by using an H-VARTM process.

In some embodiments, the present invention provides a composite material having improved interlaminar properties compared to composite materials formed using conventional methods of manufacturing the same.

In some embodiments, the present invention provides an article of manufacture comprising at least one fiber of a composite material formed by the processes described herein.

In some embodiments, the resulting fibers can be manufactured to cover large areas and form sheets or rolls of materials as well as store fibers on spools, spun onto a substrate placed between plies, or applied to a surface of a material to reduce damage.

### DETAILED DESCRIPTION

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a,” “an” and “the” are intended to include the plural forms as well, unless the context clearly indicates otherwise. As used herein, the term “and/or” includes any and all combinations of one or more of the associated listed items. Further, it will be understood that steps comprising the methods provided herein can be performed independently or at least two steps can be combined when the desired outcome can be obtained.

Unless otherwise defined, all technical and scientific terms used herein have the same meaning as commonly understood by one of ordinary skill in the art to which this invention belongs.

As used herein, “composite” or “composite material” refers to a combination of two or more materials. The materials generally possess different physical or chemical properties that remain separate and distinct on a macroscopic level within the finished product. For example, a fabric may be considered one material and a resin another material. The fiber reinforcements of the fabric in a composite can provide mechanical properties such as stiffness, tension and impact strength. The resin material can provide physical characteristics such as resistance to fire, weather, ultraviolet light and chemicals.

### 1. Vacuum Assisted Resin Transfer Moulding (VARTM) System

Vacuum assisted resin transfer moulding (VARTM) system refers to the materials, apparatus and/or equipment used to conduct a VARTM process, including a mold, peel ply, resin flask, sealing tape, flow media, tubing and bagging materials. It should be noted that VARTM is a variation of the Seemann Composite Resin Infusion Process (SCRIMP) (See U.S. Pat. Nos. 5,316,562 and 4,902,215). Generally, the SCRIMP process introduces liquid resin from an external source into the fabric by a resin inlet port. The resin flow is through the thickness of the fabric by the use of a resin distribution medium. This medium allows a resin to flow quickly over the surface area as it infuses the thickness of the fabric or preform. During VARTM, dry fabric is placed onto a mold and vacuum bagged simultaneously with a resin distribution line, a vacuum line and distribution media. A low viscosity resin is drawn into and through the fabric via a vacuum line. The resin distribution media allows the resin to completely infiltrate through the thickness of the fabric or completely wet through the fabric. This process may eliminate a noticeable amount of the voids or dry spots of the composite panel.

### 2. Heat-Vacuum Assisted Resin Transfer Moulding (H-VARTM) System

Heat-vacuum assisted resin transfer moulding (H-VARTM) system refers to a resin transfer moulding process as described in U.S. patent application Ser. No. 12/361,224, the contents of which are incorporated herein by reference in its entirety.

The materials, apparatus, and/or equipment can include the mold, peel ply, resin flask, sealing tape such as mastic, flow media and tubing and bagging materials. These materials are readily available.

Standard molds such as Formica® countertops, polycarbonate or Lexan® generally do not perform well at temperatures above 121° C. (250° F.). Accordingly, a new mold was designed from tempered glass. The glass mold surface is smooth and flat and generally does not warp or delaminate with increased temperature and further provides a desirable surface for adherence of the sealing tape for vacuum of the panel. To ensure low viscosity of the resin throughout the flow process, a heating apparatus, such as a heating pad or blanket, of the size of the glass mold and a controller were placed under the mold, and insulation was further placed beneath the heating pad to reflect the heat into the fabric. Thermocouples were used to monitor the heat under and across the setup mold and on the resin input tube. A heating pad was wrapped around the resin flask to maintain the temperature of the resin during infusion. The heating pad can be used to cure the composite without an oven by covering the setup with an insulative cover during the post-flow cycle for the manufacturer's suggested cure period. The panel can also be placed into an oven for curing, if desired.

The temperature of the entire VARTM system was increased to achieve the best flow of the resin through the material. Once the temperature for the correct viscosity was determined, this temperature was made consistent across the panel. The gradient between the bottom of the glass to the outermost bag on the top was minimized. This even heating allowed even coating and distribution of the resin. Multiple thermocouple probes were located at various locations on the insulating material, also on the bottom of the glass, and at several locations spaced on the bag over the fabric and on the resin flask and input tubing. Once the temperature was stabilized (within +/−17.2° C. (1° F.)) and the temperature over the panel was maintained consistently for about 20 minutes, the panel was flown with resin.

Each laboratory should be aware of several parameters upon starting this procedure. First, the ambient temperature in the laboratory should be measured and maintained. The panel size should also be taken into account, if post-curing in an oven is desired. The entire panel must fit into the oven for post cure. The materials used for H-VARTM should be able to withstand the range of temperatures used to cure the resin. A piece of fiberglass insulation was placed between the tabletop and a heating pad. For added insulation, a piece of extruded polystyrene (EPS) foam was purchased at a local hardware store and the fiberglass insulation was placed on top. A thermocouple controller is not recommended, as this type of controller does not consider the different temperatures over the panel. A separate digital thermocouple system was used to monitor the various temperatures in the setup. In some embodiments, a minimum of six thermocouple probes was placed throughout the setup. A variable temperature controller was used with the heating blanket in order to control the temperature of the setup.

A test was performed to ensure that all the temperatures are within tolerance. By adjusting the controller, the temperature variations indicate to the user how the heating system responds to the fluctuations in the temperature of the mold. This location was marked on the controller face and then turned off and the system was subsequently allowed to cool down to ambient temperature. The entire process was repeated until the set point was accurately determined.

Once the two pieces of insulating material were laid onto the table and the heating pad was placed on top of the materials, the glass mold was positioned on top of the heating pad. The thermocouple probe was placed on the EPS insulation and one on the bottom of the glass mold in the center. A piece of Mylar® was cut and placed on the glass mold and centered. A piece of peel ply was cut and centered onto the Mylar®. The plies of fabric were cut and aligned onto the peel ply. The fabric was adjusted accordingly with half an inch left between the fabric and the edge of the peel ply and approximately 4 inches on the other end. Another piece of peel ply was cut to the same size as the previous peel ply and aligned with the bottom piece. The vacuum and resin input lines were placed by cutting a piece of spiral tubing and a piece of PVC vacuum line and inserting approximately 7 inches of spiral line into the vacuum line. A piece of mastic sealant tape was taped around the intersection of the two in order to hold the spiral tubing in place. Another piece of sealant tape was used tape off the end of the spiral tubing. This section of connected spiral and vacuum tubing was placed and taped to the Mylar® after sliding the spiral tubing into the half-inch section remaining as mentioned above. The spiral tubing was adjusted so that the taped edge extended approximately 2 inches from the peel ply. The spiral tubing on the opposite end was gripped at the intersection and gently pulled and taped onto the Mylar®. This process of making a spiral and vacuum tubing setup was repeated. A second piece of tubing was placed on the other end of the setup approximately 3½ to 4 inches from the fabric and taped to the Mylar® in the same manner as discussed above. On this end, the peel ply was placed under the spiral tubing. A piece of resin distribution media was cut and placed onto the peel. The resin distribution media was adjusted to leave half an inch from either side of the fabric length under the peel ply. The resin distribution media was also placed under the spiral tubing and extended to the opposite end and stopped a half inch from the vacuum line located between the peel plies.

Mastic was placed around the edge of the Mylar® and the vacuum tubing was sealed into the mastic. Bagging material was cut approximately 1″ larger than the mastic and pressed onto the mastic and the material was sealed. Mastic was placed around the first bag and a second bag was cut and sealed onto the mastic. The inner bag had a vacuum applied and was allowed to stabilize. A vacuum gauge was used to measure the vacuum. Once the inner bag was tested and passed, vacuum was applied to the outer bag and tested. The vacuum was applied for approximately 5 hours to remove any trapped air.

After completing the setup, the setup was placed on the heating pad and insulation. The thermocouple probes were applied in various locations over the fabric panel and on the resin input line and resin flask. A standard heating pad was placed around the resin flask to maintain the resin temperature in the flask during flow of the resin. Once the temperature was stabilized, the panel was flown. Specifically, the resin and catalyst were mixed, stirred and degassed for 10 minutes. The resin was placed into an oven and adjusted to the determined temperature, which was maintained for approximately 20 minutes. A locking jaw was placed onto the input line between the flask and the panel in order to control the flow rate of the resin through the panel. The resin was then poured into the resin flask and the cover was placed on top. The locking jaw was opened slowly and the resin was allowed to flow into the fabric. The flow rate was adjusted between ¼″ and half an inch per minute. The flow rate was measured by placing marks on the panel once the resin entered the fabric and extended across the entire width. The flow was measured for approximately one minute. As the resin began to back up in the vacuum line and air bubbles began to decrease, the vacuum line was clamped. The temperature controller was turned off and the panel temperatures were allowed to drop, thereby changing the viscosity. All tubing was clamped and the glass mold was placed onto a shelf in the oven and the post-cure process was initiated.

### 3. Resin Selection

The selection of resin is dictated by the end use of the composite. It can be influenced by factors such as mechanical properties, environmental resistance, cost and manufacturability. Accordingly, the properties desired in the final composite should be considered. The most common resins for aerospace applications are thermoset resins, such as esters and epoxies. Some of the most common epoxies used are tetraglycidyl methylene dianiline (TGMDA) and diglycidyl ether of biphenol A (DGEBA).

The most common resins for aerospace applications are thermoset resins, such as esters and epoxies. Thermoset resins polymerize to a permanently solid and infusible state upon the application of heat. Once the thermoset resin has hardened, it cannot be reliquidified without damaging the material. Thermoset resins have excellent adhesion, high thermal stability, high chemical resistance and less creep than thermoplastics. Since their viscosity is low, the fabric can be completely wetted prior to the end of the gel time. Vinyl ester resins have a higher failure strain than polyester resins. This characteristic improves the mechanical properties, the impact resistance and the fatigue performance. The formulation process for vinyl esters is complex. The procedure consists of weighing out and mixing a promoter, a catalyst and a retarder by specific percentages to the resin weight. The promoter expedites the curing process. The catalyst promotes or controls the curing rate of the resin and the retarder absorbs any free radicals remaining once the exothermic reaction begins. As stated previously, the thermoset resin cures when heat is applied. The heat is generated by the interaction of the resin with the catalyst. The other two components control the rate of cure. Most vinyl esters cure at ambient room temperature. Thermoplastic resins flow when subjected to heat and pressure, and then solidify on cooling without undergoing cross-linking. Thermoplastic resins can be reliquidified since the material does not cross-link.

Polymerization is the chemical reaction in which one or more small molecules combine to form a more complex chemical, with a higher molecular weight. Typical examples are polyethylene, nylon, rayon, acrylics and PVC (polyvinyl chloride). Cross-linking is the joining or intermingling of the ends of the chemical bonds that make the material stronger and harder to pull apart, thus providing good mechanical properties.

Vinyl ester resins (or esters generally) may be chemically similar to both unsaturated polyesters and epoxy resins. They were developed as a compromise between the two materials, providing the simplicity and low cost of polyesters and the thermal and mechanical properties of epoxies. Vinyl esters can also be used in wet lay-ups and liquid moulding processes such as RTM. Unsaturated polyester resins are Alkyd thermosetting resins characterized by vinyl unsaturation in the polyester backbone. The definition of unsaturation is any chemical compound with more than one bond between adjacent atoms, usually carbon, and thus reactive toward the addition of other atoms at that point. Alkyd resins are polyesters derived from a suitable dibasic acid and a polyfunctional alcohol. A dibasic acid is an acid that contains two hydrogen atoms capable of replacement by basic atoms or radicals. A radical is either an atom or molecule with at least one unpaired electron, or a group of atoms, charged or uncharged, that act as a single entity in the reaction. Carboxyl groups also react with amine groups to form peptide bonds and with alcohols to form esters. Condensation polymerization occurs when monomers bond together through condensation reactions. Typically, these reactions are achieved through reacting molecules that incorporate alcohol, amine or carboxylic acid (also known as organic acid) functional groups. These unsaturated polyesters are most widely used in reinforced plastics.

Epoxy resins are a family of thermosetting resins generally formed from low molecular weight diglycidyl ethers of bisphenol A. Depending on the molecular weight, the resins range from liquids to solids and can be cured with amines, polyamides, anhydrides or other catalysts. Epoxy resins are also widely used in reinforced plastics because they have good adhesion to fibers. In addition, their low viscosities are effective in wetting various reinforcing materials. In the aerospace market, the most widely used resins are epoxy resins. They have a high curing temperature of around 350° F. (177° C.), which places their T_{g} at 302° F. (150° C.). T_{g} is the glass transition temperature. No other resin on the market can contend with this high T_{g}. epoxies have high fracture toughness, which make their fatigue performance superior to vinyl esters. They also have a low cure shrinkage rate compared to vinyl esters, so there is less possibility of cracking or crazing during the cure of components. The formulation of epoxies is also simple; it consists of two parts, the epoxy and the curing agent. The ratio of these two components provides the rate at which the mixture cures. The epoxy determines the mechanical properties and the curing agent determines the cure temperature. As noted previously, some of the most common epoxies used are TGMDA (tetraglycidyl methylene dianiline) and DGEBA (diglycidyl ether of biphenol A). The TGMDA epoxy has higher mechanical properties and higher T_{g} than the DGEBA epoxy. The DGEBA epoxy has a higher failure strain and lower water absorption than the TGMDA epoxy.

A composite is a combination of two or more materials. The fabric is considered the first material and the resin the second material. The fiber reinforcements in the composite provide mechanical properties such as stiffness, tension and impact strength. The resin matrix provides physical characteristics such as resistance to fire, weather, ultraviolet light and chemicals. When the total system of the composite is subjected to loading, the fabric, individual fiber or tows carry the majority of the load. The selection of the resin requires ample consideration due to the interconnection of the fiber and the resin. The type of resin determines the manufacturing process, environmental temperature, and the corrosion resistance of the final composite. In the production of aircraft, high glass transition temperature (T_{g}), high damage tolerance, high impact resistance and high fatigue life are the important factors in determining the materials to be used. The glass transition temperature is the temperature at which an amorphous polymer undergoes a non-reversible change from a viscous or rubbery material to a hard or brittle material or vice versa. Therefore, the T_{g} provides a limit for the upper case service conditions. Glass transition temperature is called by several names, for instance, ASTM D648 terms it “heat distortion temperature”. The gel time of the resin is another factor that is used in the selection of the resin. Gel time is the time from the initial mixing of the resin with its curing agent to the point where the viscosity of the mixture increases to a point where the flow of the resin through the fabric ceases. Manufacturers suggest that the gel time is the time that it takes to double the resin's starting viscosity value.

Suitable resins include those having suitable characteristics to DM 411-350 vinyl ester manufactured by the Dow Chemical Company, Inc. and EPON® Resin Systems manufactured by Resolution Performance Products, Inc such as Epon 9504, Epon 862 and Epon 826. Both resins types have high T_{g}'s. DM411-350 is used in adverse chemical environments, and its applications include chemical processing, pulpwood and paper processing. It is used in the food and beverage industry, but it is not currently being used in aerospace applications. EPON® resins have high tensile strength and elongation properties, which are important in composite applications. EPON® resins are a two-part system. The second part is EPI-Cure® Curing Agent. The EPON® resins have viscosities that work will between the 100 to 350° F. range and are easy to mix and work with in the manufacture of composites.

Embodiments of the present invention will be further explained with reference to the following example, which is included herein for illustration purposes only, and which is not intended to limit the invention.

### Example

### 1. Electrospinning

Mechanical properties of fibers show marked improvement with reduction in diameter, hence development of a continuous nanoscale one-dimensional nanodiameter fiber structure is important. The Drawing, Template Synthesis, Phase Separation, Self assembly methods useful for developing 1-D nanostructures have their own limitations [3]. In contrast, electrospinning is a process that can be employed to produce uniform diameter fibers in random as well as organized fashion with multitudes of configurations in the form of contents and assemblies depending upon the starting material. For the past decade, electrospinning has become a convenient process to produce uniform diameter nanofibers on a mass scale from a variety of polymers, ceramics and their composites. Electrospinning has attracted research focus because of the simplicity, versatility and mass scale nature of the process. Numerous polymers, mainly in dissolved form and some in melt form have been successfully electrospun [4].

The basic electrospinning process is a derivation of the electrostatic spinning process introduced by Formahals in 1934 [5]. Electrospinning is a non-contact drawing process in which a polymer droplet emanating from the tip of a spinneret is attracted toward a grounded collector under the action of electrical potential difference applied and surface tension of the droplet. The electro-static forces cause the droplet to stretch, resulting in bending instability and whipping of the elongated jet producing fibers of nano-scale diameter (i.e., nanofibers) with exceptionally long lengths. Evaporation of solvents takes place as the nanofibers are deposited on a grounded collector. Splaying is not dominant in reduction of diameter of the nanofibers. By controlling process parameters and properties of the polymer, ceramic or composite starting solution, fiber diameters from 3-900 nanometers can be produced.

### 2. Test Results

### A. Processing of Electrospun Glass Nano Fibers

Electrospun nanofibers used in fiber glass polymer matrix hybrid composite reinforcement are produced from TEOS Sol-Gel. The experimental electrospinning setup employed in this experiment has four operating components involved actively in the process—spinnerate at a positive electric potential, grounded collector plate, a high voltage electrical supply and solution dispensing pulp. A dispensing pump controls the rate of Sol-Gel discharge at the spinnerate tip. Controllable variables associated with TEOS Sol-Gel are viscosity, elasticity, conductivity and surface tension. These variables are dependent upon inherent properties of solute and solvent based on their molecular weight and cross linking of polymer chains etc., which are further influenced by temperature, humidity and aging time.

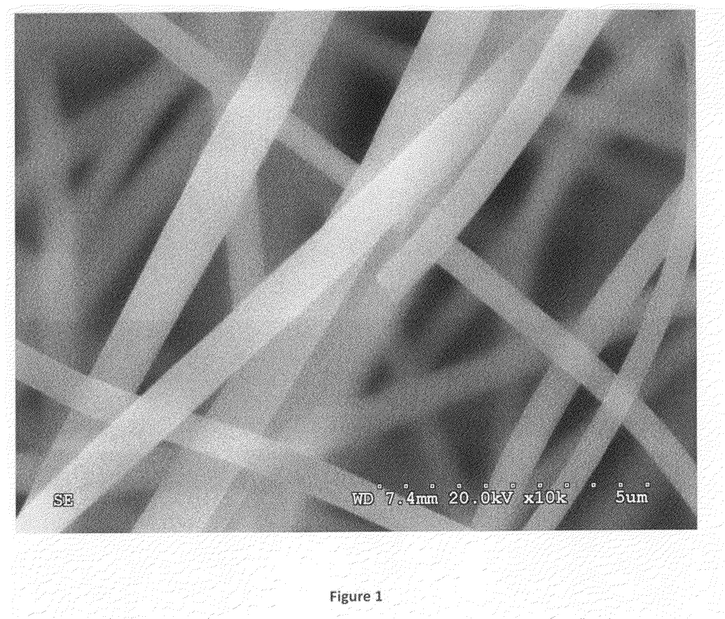

The scanning electron microscope (SEM) micrograph of the formed electrospun glass fibers is shown in FIG. 1. The minimum diameter of the electrospun fibers produced is observed to be about 300 nanometers as spun and about 100 nanometers after heat treatment. The electrospun TEOS Sol-Gel silica fibers were cured at various temperatures for the evaporation of solvents to form optimal SiO₂ content. These electrospun silica glass nanofiber coated E-Glass woven sheets were subsequently impregnated with epoxy resin (EPON® 862) using the H-VARTM method [6; and as described herein] to fabricate the nanoengineered hybrid composite laminates. Traditional composite laminates using the same number of woven glass fiber mat layers and the epoxy resin were also fabricated to form the baseline for the comparison via the interlaminar characterization techniques as discussed next.

### B. Characterization

The effect on inter-laminar properties of the nano-engineered hybrid composites was studied using (a) Modified Short Beam Shear (MSBS) [7] tests and (b) Short Beam Shear (SBS) tests (ASTM Standard D2344), and c) Double Cantilever Beam Test (ASTM Standard D5528). Hybrid composite panels formed from two different curing temperatures (300° C. and 900° C.) of TEOS electrospun fibers were tested and compared with baseline composite panels without electrospun fibers. Table 1 shows the data obtained from the current MSBS and SBS tests.

TABLE 1
Average and Standard Deviation of GIC values for specimen tested
(N-neat specimen without nanofiber. D-specimen with nanofiber)

| | Average Value | Standard Deviation |
|---|---|---|
| Specimen No. | for G_{IC} (J/m²) | for G_{IC} (J/m²) |
| N2000 | 874.81 | 308.17 |
| N3000 | 1176.29 | 416.51 |
| N4000 | 1110.93 | 332.26 |
| D1950 | 980.59 | 271.45 |
| D3950 | 935.47 | 253.43 |
| D4950 | 1038.33 | 347.45 |

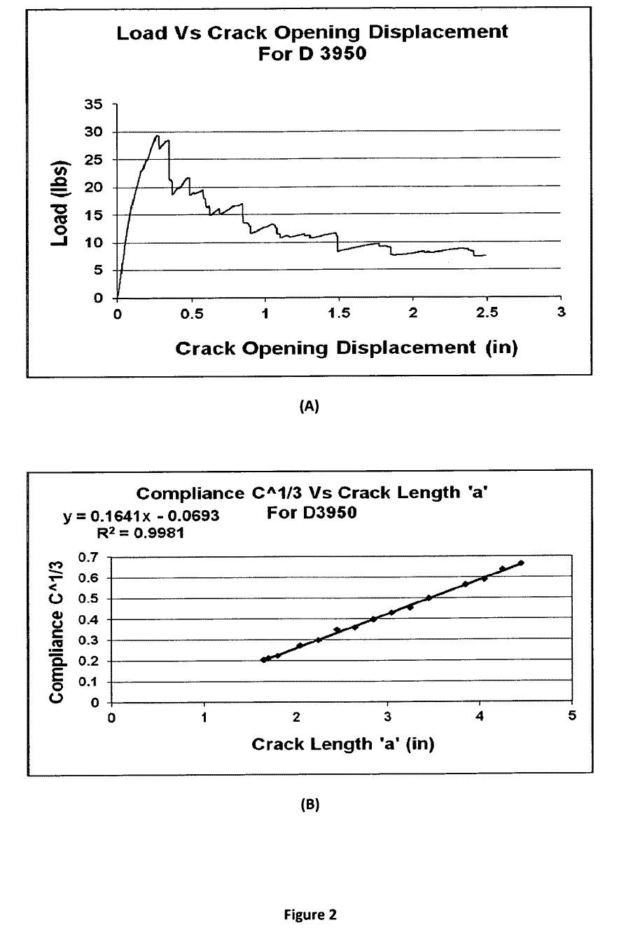

The experimental test data indicates over 20% improvement in shear strength in the electrospun layered hybrid composites compared to the conventional two-phase composites. FIG. 2 shows SEM factographs depicting interaction of TEOS electrospun fibers in the MSBS test. The MSBS and SBS experimental data obtained indicates over 20% improvement in the delamination resistance of the nanoengineered hybrid composite with electrospun nanofiber layers compared to the traditional two-phase composite. The heat treatment curing temperature during the electrospun process used for the conversion of the Sol-Gel into silica (SiO₂) influences the nanofiber diameter and the subsequent interlaminar properties. DCB test results, however, show a decrease in the average interlaminar fracture toughness (G_{IC}) values for the specimens with electrospun nano fiber reinforcement based on the current preliminary results. This can be attributed to the amount of electrospun nanofibers in the composite laminates used in the current DCB tests. The electrospun nanofiber layers are around 15% by volume in case of SBS and MSBS test specimens while it was around 5% by volume in case of DCB test specimens. Also, it was observed that DCB test specimens showed some resin starvation in electrospun nanofiber layers. An increase in volume of the nanofiber and the complete resin wetting of electrospun nanofiber layers may contribute to improvement in the Mode-I fracture toughness characteristics of these hybrid composites.

### REFERENCES

[1] Bolick, R. L., Ph.D. Thesis, A comparative study of unstitched, stitched, and z-pinned plain woven composites under fatigue loading, North Carolina A & T State University, 2005.
[2] M. V. Hosur, U. K. Vaidya, C. Ulven, and S. Jeelani, Performance of stitched/unstitched woven carbon/epoxy composites under high velocity impact loading, Composite Structures 64 (2004) 455-466.

### [3] Y. Xia et al., One Dimensional Nanostructures: Synthesis, Characterization and Applications, Advanced Materials, 2003, 15, No. 5, pg. 353-389.

[4] S. Ramakrishna et. al., A review on polymer nanofibers by electrospinning and their applications in nanocomposites, Composites Science and Technology 63 (2003) 2223-2253.

[5] A. Formhals, Process and apparatus for preparing artificial threads. U.S. Pat. No. 1,975,504, 1934.

### [6] R. L. Bolick, A. D. Kelkar, J. S. Tate, Interlaminar Shear Strength Comparison Of Stitched, Unstitched, And Braided Composites, SAMPE, Nov. 3, 2005.

[7] K. Shivakumar et. al. Modified Short BeamShear Test for Measurement of Interlaminar Shear Strength of Composites, Journal of Composite Materials, Vol. 37, No. 5, 453-464 (2003).

The foregoing is illustrative of the present invention, and is not to be construed as limiting thereof. The invention is defined by the following claims, with equivalents of the claims to be included therein.

That which is claimed is:

1. A process for forming a composite material comprising:
(a) subjecting a silica polymer material in a solvent to an electrospinning technique; and
(b) impregnating the electrospun product of (a) with a resin material, wherein said process of impregnating the electrospun product is carried out by using a heat-vacuum assisted resin transfer moulding (H-VARTM) process.

2. The process of claim 1, wherein the heat-vacuum assisted resin transfer moulding process comprises subjecting the electrospun product of (a) to a vacuum assisted resin transfer (VARTM) system that is subjected to an increased temperature, wherein said temperature is stabilized and maintained for a predetermined time prior to introducing the resin material into the VARTM system.

3. The process of claim 2, wherein the increased temperature is in the range of about 100° to 550° F.

4. The process of claim 2, wherein the increased temperature is in the range of about 200° to 550° F.

5. The process of claim 2, wherein the predetermined time is at least about 20 minutes.

6. The process of claim 1, wherein the silica polymer material is a fiber-reinforced polymer.

7. The process of claim 1, wherein the resin material is a thermosetting resin.

8. The process of claim 7, wherein the thermosetting resin is selected from the group consisting of esters and epoxies.

9. The process of claim 7, wherein the thermosetting resin is selected from the group consisting of tetraglycidyl methylene dianiline (TGMDA) and diglycidyl ether of biphenol A (DGEBA).

10. An article of manufacture comprising at least one fiber of a composite material formed by the process of claim 1.
